(19) United States
(12) Patent Application Publication
(10) Pub. No.: US 2026/0310511 A1
(43) Pub. Date: Oct. 8, 2026

(54) COMPUTING SYSTEM USING DYNAMIC OPTICAL SWITCH AND OPERATION METHOD THEREOF

(71) Applicant: ELECTRONICS AND TELECOMMUNICATIONS RESEARCH INSTITUTE, Daejeon (KR)

(72) Inventors: Daeub KIM, Daejeon (KR); Bup Joong KIM, Daejeon (KR); Chanho PARK, Daejeon (KR); Jongtae SONG, Daejeon (KR); Ji Wook YOUN, Daejeon (KR); Jun Ki LEE, Daejeon (KR); Kyeong-Eun HAN, Daejeon (KR)

(73) Assignee: ELECTRONICS AND TELECOMMUNICATIONS RESEARCH INSTITUTE, Daejeon (KR)

(21) Appl. No.: 19/635,575

(22) Filed: Mar. 31, 2026

(30) Foreign Application Priority Data
Apr. 3, 2025 (KR) 10-2025-0043236
Jul. 4, 2025 (KR) 10-2025-0090020

(51) Int. Cl. G06F 9/50; G06E 1/00; G06F 1/12; G06F 13/36

(52) U.S. Cl. CPC G06F 9/5027; G06E 1/00; G06F 1/12; G06F 13/36

(57) ABSTRACT

A computing system is provided. The computing system comprises a plurality of computing resources connected based on a high-speed compute interconnect; a dynamic optical switch for setting connection paths between the plurality of computing resources; and a controller for setting a first computing resource among the plurality of computing resources as a master and controlling the setting of the connection paths between the plurality of computing resources by the dynamic optical switch, wherein the first computing resource set as the master is configured to control the dynamic optical switch.

### CROSS-REFERENCE TO RELATED APPLICATIONS

This application claims priority under 35 U.S.C. § 119 to Korean Patent Application No. 10-2025-0043236 filed on April 3, 2025, and Korean Patent Application No. 10-2025-0090020 filed on July 4, 2025, in the Korean Intellectual Property Office, the disclosure of which is incorporated by reference herein in its entirety.

### BACKGROUND

The present disclosure relates to a dynamic optical switch, and more specifically, to an optical switching technology for efficiently utilizing link bandwidth and flexibly setting communication paths for interconnects between a plurality of computing resources connected based on connection scaling-up technologies for computing resources, such as Compute Express Link and NVLink.

In a High Performance Computing (HPC) system with distributed computing resources, when the hardware specifications are the same, a crucial factor determining performance is minimizing the time required for data movement between separated memory regions. A major performance bottleneck for implementing AI (Artificial Intelligence)/HPC is related to memory access and memory bandwidth. Accordingly, solving new challenges such as memory and communication bottlenecks has become important, and the need for a structure where various computing resources can directly access each other's memory to read and write is emerging.

Compute Express Link (CXL) and NVLink switch fabrics support the scaling-up of connections between computing resources according to their respective protocols. However, the interfaces used for this have a limitation in that it is difficult to electrically connect computing resources (CPU, accelerator, memory, storage, etc.) in racks that are more than a few meters apart, or between computing resources and a switch.

### SUMMARY

An object of the present invention is to provide a dynamic optical switch-based computing system and an operation method thereof that can overcome distance limitations, enable reuse regardless of link bandwidth, and effectively utilize bandwidth exceeding several tens of Tbps.

According to an embodiment of the present disclosure, a computing system comprises: a plurality of computing resources connected based on a high-speed compute interconnect; a dynamic optical switch for setting connection paths between the plurality of computing resources; and a controller for setting a first computing resource among the plurality of computing resources as a master and controlling the setting of the connection paths between the plurality of computing resources by the dynamic optical switch, wherein the first computing resource set as the master is configured to control the dynamic optical switch.

In one embodiment, the plurality of computing resources comprises at least one of a CPU (Central Processing Unit), an accelerator, and a memory, and the high-speed compute interconnect comprises an open interconnect link between the plurality of computing resources.

In one embodiment, the first computing resource sets a time window, the time window is set as a communication channel time for the plurality of computing resources, and the time window is subdivided into a plurality of time slots configured to be allocated to the plurality of computing resources.

In one embodiment, each of the plurality of time slots comprises: a data transmission period, which is a time period for transmitting requests, responses, and data between the plurality of computing resources; and a guard period, which is a time period for preventing collisions and interference of requests, responses, and data, and for switching stabilization.

In one embodiment, an input/output bandwidth allocation capacity for each of the plurality of computing resources is determined based on a bandwidth weight, and the bandwidth weight is adjusted based on the number of flits included in each of the plurality of time slots.

In one embodiment, the first computing resource provides switching time information for transmitting or receiving requests, responses, and data to a computing resource connected to the first computing resource in a first time slot among the plurality of time slots, wherein the switching time information comprises at least one of a time window, the number of time slots, an index of an assigned time slot, and a maximum number of flits.

In one embodiment, the plurality of computing resources comprises a second computing resource and a third computing resource, and the second computing resource is configured to: set connection paths with the third computing resource for each of the plurality of time slots based on the switching time information, transmit or receive requests, responses, and data between the resources in each of the plurality of time slots, and stop transmitting or receiving requests, responses, and data in unallocated time slots among the plurality of time slots.

In one embodiment, the second computing resource is configured to: recover a received clock from a received signal, synchronize a switching time based on the received clock and the switching time information, and use an internal clock corrected based on the received clock as a transmission clock.

In one embodiment, the dynamic optical switch comprises: a switch module having a Mach-Zehnder (MZ) interference structure; a coupler for splitting and combining optical signals of the switch module; and a switch driver for providing a high-speed voltage optimized for the switch module.

In one embodiment, the dynamic optical switch is configured bidirectionally, and to manage and control switching of connection paths between the plurality of computing resources as a pair of a transmission side and a reception side of optical signals.

In one embodiment, the switch module comprises a Mach-Zehnder modulator, and the Mach-Zehnder modulator is composed to switch the connection paths based on a phase difference between optical signals at an output port based on a voltage applied to the Mach-Zehnder modulator.

In one embodiment, the first computing resource delivers a switching signal and a trigger signal to the dynamic optical switch, and the switch driver controls the switch module by splitting the high-speed voltage based on the received trigger signal.

According to another embodiment of the present disclosure, a computing system comprises: a plurality of computing resources connected based on a high-speed compute interconnect; a dynamic optical switch for setting connection paths between the plurality of computing resources; and a controller for setting a first computing resource and a second computing resource among the plurality of computing resources as masters and controlling the setting of the connection paths between the plurality of computing resources by the dynamic optical switch, wherein the first computing resource and the second computing resource generate and deliver switching time information for the plurality of computing resources, the controller sets the first computing resource as a primary master, the second computing resource which is not the primary master is synchronized based on the first computing resource, and the first computing resource is configured to control the dynamic optical switch.

In one embodiment, the first computing resource sets and controls connection paths of optical signals for communication for each time slot based on the switching time information of the plurality of computing resources.

In one embodiment, the dynamic optical switch comprises: a switch module having a Mach-Zehnder (MZ) interference structure; a coupler for splitting and combining optical signals of the switch module; and a switch driver for providing a high-speed voltage optimized for the switch module.

According to another embodiment of the present disclosure, in an operation method of a computing system for controlling connection paths and a bandwidth between a plurality of computing resources connected based on a high-speed compute interconnect, the method comprises: setting a first computing resource among the plurality of computing resources as a master, by a controller included in the computing system; setting connection paths of optical signals for communication between the plurality of computing resources, by a dynamic optical switch included in the computing system; and transmitting or receiving requests, responses, and data based on the optical signals, by the plurality of computing resources.

In one embodiment, the operation method further comprises generating switching time information for controlling the plurality of computing resources, and generating switching time information for controlling the plurality of computing resources comprises: setting a time window by the first computing resource; determining a bandwidth weight based on a transmission demand and a reception demand of the plurality of computing resources by the first computing resource; subdividing the time window into a plurality of time slots and allocating the plurality of time slots based on the bandwidth weight by the first computing resource; and providing the switching time information in each of the plurality of time slots by the first computing resource, wherein the switching time information includes at least one of a time window, the number of time slots, an index of an assigned time slot, and a maximum number of flits.

In one embodiment, setting the connection paths of the optical signals for communication between the plurality of computing resources comprises: delivering a switching signal and a trigger signal to a switch driver included in the dynamic optical switch by the first computing resource; applying a voltage to a switch module included in the dynamic optical switch based on the switching signal and the trigger signal by the switch driver; and switching the connection path by adjusting a phase difference between optical signals at an output port based on the voltage by the switch module.

In one embodiment, transmitting or receiving requests, responses, and data based on the optical signals comprises: transmitting or receiving requests, responses, and data in flit units for allocated time slots by the plurality of computing resources; and stopping the transmission or reception of requests, responses, and data for unallocated time slots by the plurality of computing resources.

In one embodiment, the operation method further comprises generating new switching time information by the first computing resource.

### BRIEF DESCRIPTION OF THE FIGURES

The above and other objects and features of the present disclosure will become apparent by describing in detail embodiments thereof with reference to the accompanying drawings.

FIG. 1 illustrates a computing system according to an embodiment of the present disclosure.

FIG. 2 illustrates a computing system according to another embodiment of the present disclosure.

FIG. 3 illustrates a computing system according to another embodiment of the present disclosure.

FIG. 4 is a diagram illustrating time window-based switching according embodiment of the present disclosure.

FIG. 5 illustrates a computing system according to another embodiment of the present disclosure.

FIG. 6 is a diagram illustrating time window-based switching according to another embodiment of the present disclosure.

FIG. 7 is a flowchart illustrating an operation method of the computing system of FIG. 1.

FIG. 8 is a flowchart illustrating an operation method for a master to generate switching time information in step S200.

FIG. 9 is a flowchart illustrating an operation method for a master to set connection paths of optical signals in step S300.

FIG. 10 is a flowchart illustrating an operation method for a master and a plurality of time slots to transmit or receive data in step S400.

FIG. 11 is a flowchart illustrating an operation method for determining a reference time of switching time information for a plurality of computing resources based on a plurality of masters in step S200.

### DETAILED DESCRIPTION

Hereinafter, embodiments of the present disclosure will be described clearly and in detail so that those skilled in the art to which the present disclosure pertains can easily carry out the disclosure.

In the present document, each of the phrases “A or B”, “at least one of A and B”, “at least one of A or B”, “A, B, or C”, “at least one of A, B, and C”, and “at least one of A, B, or C” may include any one of the items listed together in the relevant phrase, or any possible combination of all of them.

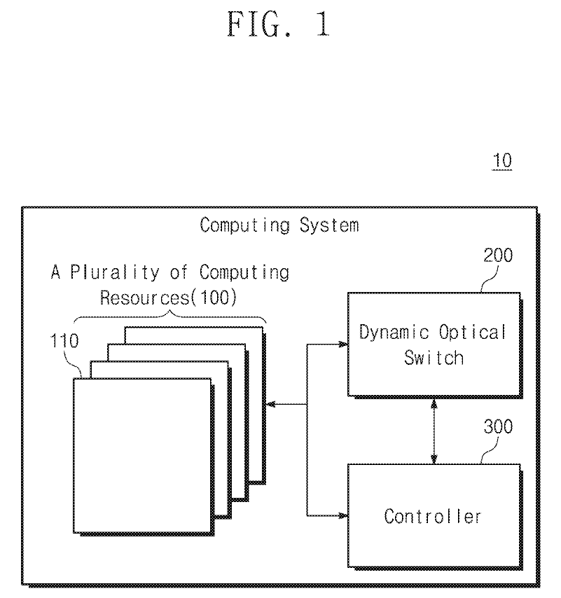

Hereinafter, embodiments of the present disclosure will be described clearly and in detail to the extent that a person having ordinary skill in the technical field of the present disclosure can easily carry them out. Hereinafter, terms such as "unit", "module" or functional blocks shown in the drawings may be implemented in the form of software configuration, hardware configuration, or a combination thereof. Hereinafter, for the sake of clarity in explaining the technical idea of the present invention, detailed descriptions of redundant components will be omitted. FIG. 1 illustrates a computing system according to an embodiment of the present disclosure. Referring to FIG. 1, a computing system 10 may include a plurality of computing resources 100, a dynamic optical switch 200, and a controller 300. The plurality of computing resources 100 may be referred to as a computing resource pool.

The plurality of computing resources 100 may include a first computing resource 110 set (allocated) as a master. Hereinafter, the first computing resource 110 set as the master may be referred to as the master.

In one embodiment, the master 110 may be used as an Optical Switch Controller (OSC). The master 110 may be configured as a computing resource with a specific function, such as a host CPU (Central Processing Unit). The master 110 may generate and deliver switching time information for computing resources connected to the master 110 and may set and control connection paths of an optical signal for communication for each time slot in a time window.

In one embodiment, the plurality of computing resources 100 may include at least one of a CPU, a GPU (Graphics Processing Unit), and a memory. The plurality of computing resources 100 may include all four types of interfaces (between CPU and CPU, between GPU and GPU, between CPU/GPU and memory, between CPU and GPU).

In one embodiment, each of the plurality of computing resources 100 may correspond to elements that perform computation or data processing of the computing system 10, or store data. Each of the plurality of computing resources 100 may correspond to a host CPU. Each of the plurality of computing resources 100 may include at least one CPU and a connection path. The CPU can execute at least one of an operating system (OS) and an application program.

In one embodiment, each of the plurality of computing resources 100 may correspond to an accelerator, which is a peripheral device of a host. Each of the plurality of computing resources 100 may include at least one GPU and a connection path. The graphics processing unit can provide high-speed processing and high-speed computation of specific data. Each of the plurality of computing resources 100 may include at least one special-purpose processor, such as a neural processing unit (NPU), a tensor processing unit (TPU), or a field-programmable gate array (FPGA), in addition to a GPU, depending on the data it handles. Each of the plurality of computing resources 100 may improve the computing performance of the computing system 10 by efficiently processing specialized data at the request of the host.

In one embodiment, each of the plurality of computing resources 100 may further include a cache and attached memory. Each of the plurality of computing resources 100 may be at least one memory device among fabric-attached memory, a memory expander, and/or a memory pool as a peripheral device of a host. Each of the plurality of computing resources 100 may include a plurality of memory pools and connection paths. Each of the plurality of computing resources 100 may include a memory controller and a memory that stores data under the control of the memory controller. Data processed in at least one of a host or an accelerator may be loaded into each of the plurality of computing resources 100. Each of the plurality of computing resources 100 may include volatile memory such as RAM (Random Access Memory) or SRAM (Static Random Access Memory), or non-volatile memory including at least one of flash memory type, hard disk type, multimedia card micro type, card type memory (e.g., SD, XD memory, etc.), Storage, ROM (Read-Only Memory), EEPROM (Electrically Erasable Programmable Read-Only Memory), and PROM (Programmable Read-Only Memory).

In one embodiment, each of the plurality of computing resources 100 may be spatially separated by being distributed on separate boards or separate racks.

In one embodiment, the plurality of computing resources 100 may be interconnected based on a high-speed compute interconnect. The high-speed compute interconnect may include a scaling-up link for connection between the plurality of computing resources 100, such as Compute Express Link (CXL) and NVLink. The high-speed compute link may include a CXL Switch, and NVLink may include an NVSwitch. Connection paths between the plurality of computing resources may be set through the CXL switch and the NVSwitch.

Although the embodiment of FIG. 1 exemplarily shows only one master 110, a computing system according to another embodiment of the present disclosure may include a plurality of masters. When computing resources that are not masters are connected to a plurality of masters through ports, a primary master may be set among the plurality of masters. Synchronization between the plurality of masters and the computing resources connected thereto may be achieved based on the primary master. The primary master may set and control the connection paths of optical signals for communication for each time slot in a time window based on the switching time information of the plurality of masters and the plurality of computing resources connected to the dynamic optical switch 200. The primary master may manage the switching. The plurality of masters may generate and deliver switching time information of the computing resources connected thereto. The plurality of masters may set and control the connection path of the optical signal for communication for each time slot in a time window.

The dynamic optical switch 200 may set the connection paths between the plurality of computing resources 100.

The controller 300 may set (allocate) the first computing resource 110 among the plurality of computing resources 100 as a master and may control the connection paths between the plurality of computing resources by the dynamic optical switch 200.

In one embodiment, the controller 300 may set a plurality of masters among the plurality of computing resources 100. The controller 300 may exist separately, or it may operate as an internal function of the master 110.

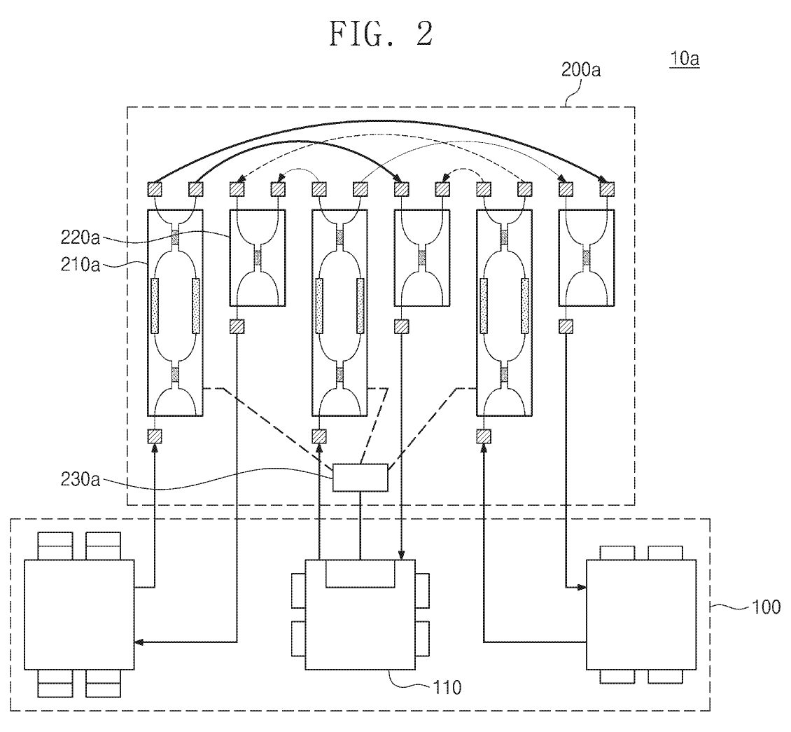

FIG. 2 illustrates a computing system according to another embodiment of the present disclosure. Specifically, FIG. 2 is a diagram illustrating the configuration of three computing resources and a dynamic optical switch connected thereto. Referring to FIG. 2, the dynamic optical switch 200a may include a switch module 210a, a coupler 220a, and a switch driver 230a.

The switch module 210a may switch the connection paths between computing resources. The switch module 210a may change the output path of requests, responses, and data output from the computing resources.

In one embodiment, the switch module 210a may have a Mach-Zehnder interferometer structure (MZI). The switch module 210a may be a Mach-Zehnder type having a 1-input 2-output (1x2) structure. The switch module 210a may include a Mach-Zehnder modulator. The switch module 210a may apply a voltage to the electrodes of the Mach-Zehnder modulator. The switch module 210a may control the interference pattern by adjusting the phase difference between optical signals at the output port based on the voltage applied to the electrodes.

The coupler 220a may split an optical signal into two or more paths or combine a plurality of optical signals into one path. The coupler 220a may be used to form a Mach-Zehnder interferometer structure and contribute to the path setting and interference condition adjustment of the optical signal.

In one embodiment, the coupler 220a may have a 2-input 1-output (2x1) structure. For example, the coupler 220a may be implemented as a Y-Branch coupler or an MMI (Multimode Interference) coupler having a 2-input 1-output (2x1) structure.

The switch driver 230a may provide a high-speed voltage optimized for the switch module 210a. The switch driver 230a may apply an appropriate voltage to the switch module 210a to enable bidirectional switching.

In one embodiment, the switch driver 230a may receive a switching signal and/or a trigger signal from the master 110 for switching of the switch module 210a. The switch driver 230a may control the switch module 210a by splitting an appropriate high-speed voltage based on the received trigger signal. In one example, the switch driver 230a may simultaneously control a plurality of switch modules included in the dynamic optical switch 200a by splitting the received trigger signal into high-speed voltages. For example, the appropriate high-speed voltage may mean an optimized (high-speed) voltage for communication between computing resources based on the switching of the switch module 210a.

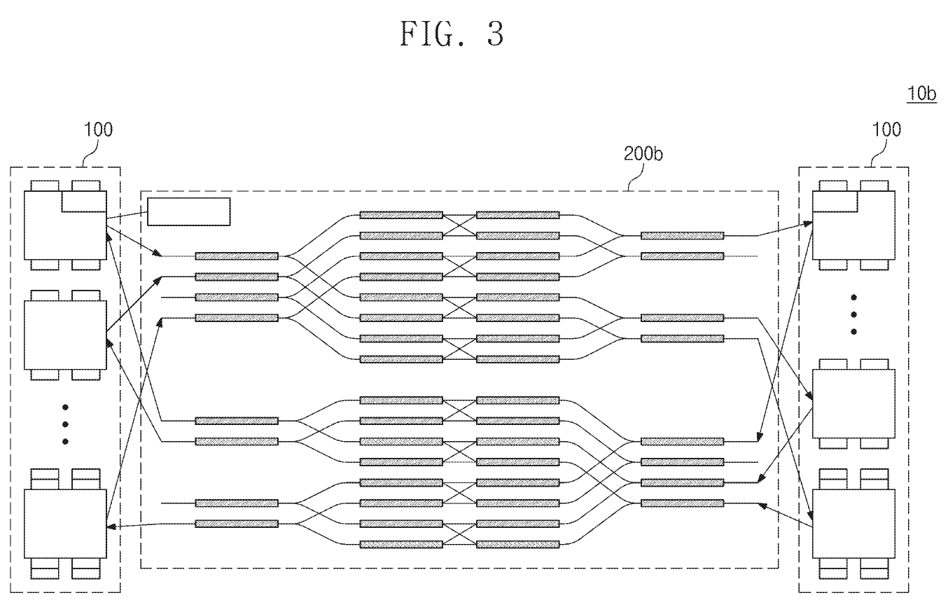

FIG. 3 illustrates a computing system according to another embodiment of the present disclosure. Specifically, FIG. 3 is a diagram illustrating dynamic optical switch in a 4x4 array.

Referring to FIG. 3, a plurality of computing resources 100 may all be connected to other accelerators (GPUs), CPUs, and memory pools through a single port for heterogeneous computing resource and memory sharing. Since the port of each computing resource is configured as a pair of input and output, the switching of the optical signal in the dynamic optical switch 200b may be managed and controlled as a bidirectional pair of input and output.

In one embodiment, the dynamic optical switch 200a, 200b may be used as an optical circuit switch (OCS) without switching operation for a certain period. The ports of the dynamic optical switch 200a, 200b may use the bandwidth exclusively. Request and response signals may be transmitted or received through the port of each computing resource without additional latency.

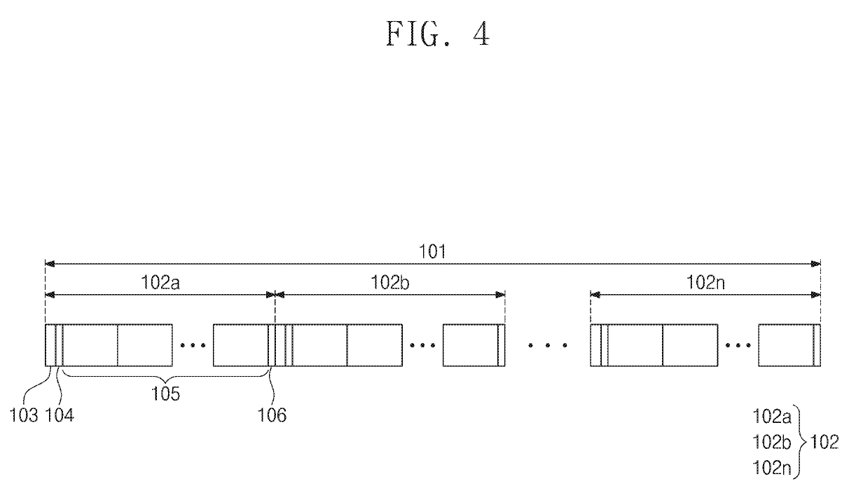

FIG. 4 is a diagram illustrating time window-based switching according to an embodiment of the present disclosure. The switching according to the embodiment of FIG. 4 may be implemented in the computing system of FIG. 1. Referring to FIG. 4, switching within the computing system of FIG. 1 may be performed based on a time window 101 and a plurality of time slots 102.

In one embodiment, the time window 101 may mean a time period allocated for transmitting or receiving requests, responses, and data to different destinations from the input port and/or output port of one computing resource. The time window 101 may be composed of the plurality of time slots 102. The plurality of time slots 102 may include a first time slot 102a, a second time slot 102b, and an nth time slot 102n. A time slot is a unit of time channel allocated for communication between a plurality of computing resources, and each slot can be allocated to a specific communication source and destination pair. The entire period of the time window 101 may be a set of a plurality of time slots 102 divided by destination. For example, the first time slot 102a may mean the communication channel time between the master 110 and a second computing resource among the plurality of computing resources, and the second time slot 102b may mean the communication channel time between the master 110 and a third computing resource among the plurality of computing resources. Hereinafter, the embodiments and features described for the first time slot 102a may be equally applied to the second time slot 102b.

In one embodiment, the allocation capacity of the input and output bandwidth of one computing resource may be determined based on a bandwidth weight. For example, based on a single port included in the master 110 accessing two devices with the same bandwidth, the weights of the two devices may be determined as 50% each.

In one embodiment, the bandwidth weight may be adjusted based on the number of flits (Flit; Flow Control Unit) included in each of the plurality of time slots 102. A flit may be a basic unit of data transmission in the computing system of FIG. 1. In this document, a request, response, and data (or frame) included in a time window and a time slot may be referred to as a flit. In this document, a flit may be used as a term corresponding to a request, response, and data, and/or may be used as a transmission unit of a request, response, and data.

In one embodiment, the first time slot 102a may include a guard time 103, which is a time period for preventing collisions and interference of requests, responses, and data and for switching stabilization, a header 104, and a data transmission period 105, which is a time period for transmitting requests, responses, and data between a plurality of computing resources. The guard time 103 may not be included in the effective bandwidth for communication. The guard time 103 may be dependent on the switching time. For example, by using a switching element with a short switching time, the guard time 103 can be shortened, and the effective bandwidth can be increased. The first time slot 102a may further include a header 104 and error detection information 106. The header 104 may include supplementary data, and the error detection information 106 may be used to verify the integrity of the data.

In one embodiment, the master 110 may provide switching time information for transmitting or receiving requests, responses, and data in the time slot allocated for each device through an Optical Compute Express Link (OCXL) and NVLink interface. For example, the switching time information may include the time window, the number of time slots, an index of the allocated time slot, and the maximum number of flits. OCXL refers to an optical-based CXL interface.

In one embodiment, computing resources other than the master 110 can synchronize time through a recovered receive clock based on the switching time information, and may use an internal clock corrected and synchronized with the receive clock as a transmission clock.

In one embodiment, the computing resources other than the master 110 may transmit switching time information for confirmation to the master 110 through the header 104 or an internal message of the OCXL and NVLink interface. For example, the switching time information for confirmation may include the time window, the number of time slots, the index of the allocated time slot, and the maximum number of flits.

In one embodiment, the header 104 may include a specific bit string or pattern. The master 110 and the computing resources other than the master 110 may identify (or determine) a reference time of the periodic switching time information based on the specific bit string or pattern included in the header 104.

In one embodiment, the master 110 may identify (or determine) a reference time of the computing resources other than the master 110 based on the specific bit string or pattern included in a field of the header 104 received at a receiver of the OCXL and NVLink interface, the switching time information for confirmation, and a fixed loop-back delay. The master 110 may adjust and/or manage the reference time as needed.

In one embodiment, the OCXL and NVLink interfaces of the computing resources other than the master 110 among the plurality of computing resources 100 may be synchronized based on switching time information from the master 110. The OCXL and NVLink interfaces of the computing resources other than the master 110 among the plurality of computing resources 100 may also synchronize the transmission clock through the clock recovery of a received signal, thereby maintaining time synchronization of a switching domain.

In one embodiment, for the plurality of computing resources 100, paths between computing resources may be generated and switched for each of the plurality of time slots 102 by an optical switch controller, based on control of the optical switch controller included in the master 110 and the switching time information provided from the master 110. The plurality of computing resources 100 may transmit or receive requests, responses, and data flits between corresponding resources in each of the plurality of time slots 102. In unallocated time slots, the transmission or reception of requests, responses, and data may be stopped.

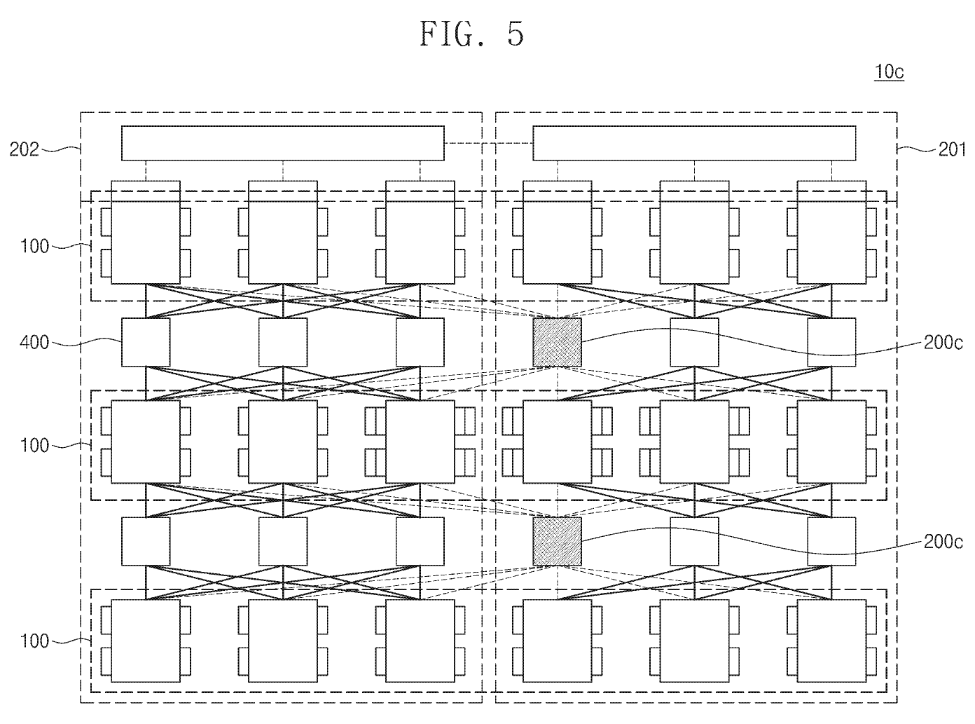

FIG. 5 illustrates a computing system according to another embodiment of the present disclosure. Specifically, FIG. 5 is a configuration diagram of a computing system connected by CXL and NVLink, to which a dynamic optical switch is applied.

In one embodiment, the computing system 10c may advance all four types of interfaces (between CPU and CPU, between GPU and GPU, between CPU/GPU and memory, between CPU and GPU) and may support optical connections. For interconnection between CPU and GPU, the computing system 10c may include an interface configured to access a connected memory of another processing device located at a remote site, in addition to a memory connected to each processing device (computing resource). Each processing device (computing resource) may recognize a memory other than its own local memory or attached memory through this interface, and may perform read and write operations thereon.

In one embodiment, a plurality of computing resources 100 included in a first rack 201 may be connected to other computing resources included in the same rack through a high-speed link switch 400, and/or may be connected to computing resources included in a separate second rack 202 through a dynamic optical switch 200c. For example, the high-speed link switch 400 may include a CXL switch and an NVSwitch.

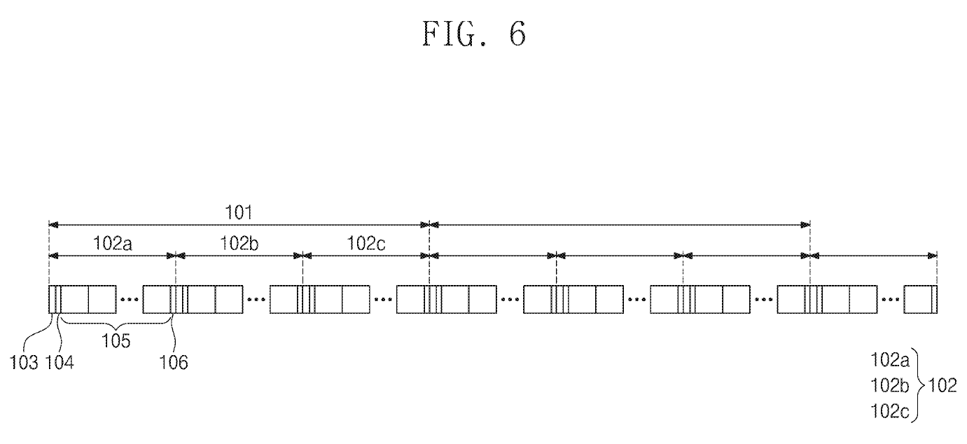

FIG. 6 is a diagram illustrating time window-based switching according to another embodiment of the present disclosure. Specifically, FIG. 6 illustrates the flow in the time domain based on connection by a switch between the transmit/receive port of a first computing resource and the ports of second to fourth computing resources.

Referring to FIG. 6, a first time slot 102a is a period for exchanging flits including requests, responses, and data in the OCXL interface of each computing resource constituting the transmit or receive ports of the first computing resource and the second computing resource. A second time slot 102b is a period for exchanging flits including requests, responses, and data in the OCXL interface of each computing resource constituting the transmit or receive ports of the first computing resource and the third computing resource. A third time slot 102c is a period for exchanging flits including requests, responses, and data in the OCXL interface of each computing resource constituting the transmit or receive ports of the first computing resource and the fourth computing resource. Hereinafter, the embodiments and features described for the first time slot 102a can be equally applied to the second time slot 102b and the third time slot 102c.

In one embodiment, the first time slot 102a may include a guard time 103, which is a time period for preventing collisions and interference of requests, responses, and data and for switching stabilization, and a data transmission period 105, which is a time period for transmitting requests, responses, and data between the plurality of computing resources. The guard time 103 may not be included in the effective bandwidth for communication. The guard time 103 may be dependent on the switching time. For example, by using a switching element with a short switching time, the guard time 103 may be shortened, and the effective bandwidth may be increased. The first time slot 102a may further include a header 104 and error detection information 106. The header 104 may include supplementary data, and the error detection information 106 may be used to verify the integrity of the data.

In one embodiment, the first computing resource may operate as the master 110. The first computing resource may transmit a reference time to computing resources other than the master based on a specific bit string or pattern of the header 104. The reference time may be used as the starting point of the period for transmitting or receiving flits that include the header, requests, responses, and data. The first computing resource may transmit flits based on the reference time.

In one embodiment, a first master among the plurality of masters may be set as a primary master, based on sharing ports of computing resources other than the master through a switch by a plurality of masters. The computing resources other than the master and the plurality of masters may be synchronized based on the primary master. For example, when the first master and the second master share the transmit or receive port of a fourth computing resource, the reference time of the fourth computing resource may be determined through the first master, the fourth computing resource may provide information for reference time confirmation to the first master, and the fourth computing resource may also provide information for reference time confirmation to the second master. The reference time of a non-primary master may be determined through the fourth computing resource and may be synchronized based on the primary master. The primary master (first master) may deliver switching time information to the computing resource(s) connected to the primary master, and the non-primary master (second master) may deliver the synchronized switching time information. That is, the switching time information delivered by the primary master may be temporally synchronized with the switching time information delivered by the non-primary master.

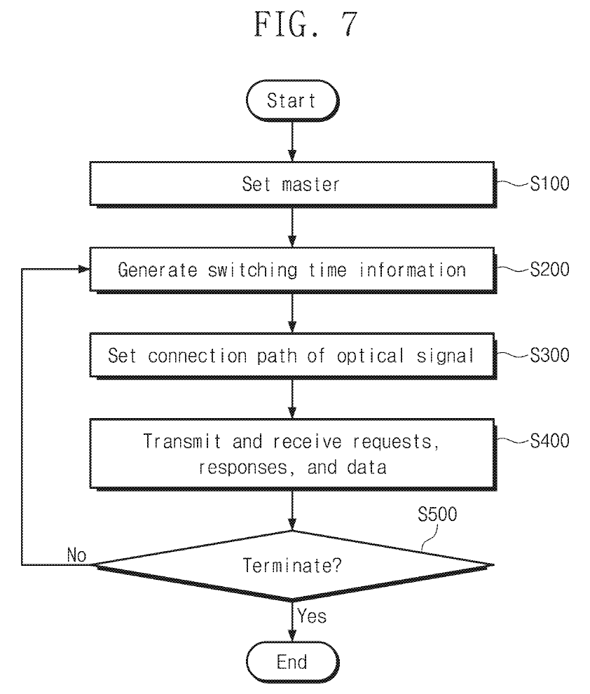

FIG. 7 is a flowchart illustrating an operation method of the computing system of FIG. 1. The operation method of the computing system 10 may include steps S100 to S500. FIG. 7 will be described together with FIG. 1.

Referring to FIGS. 1 and 7, in step S100, the controller 300 may set (allocate) the first computing resource 110 among the plurality of computing resources 100 as a master. In step S200, the master 110 may generate switching time information for controlling the plurality of computing resources 100. In step S300, the dynamic optical switch 200 may set connection paths of optical signals for communication between the plurality of computing resources 100. In step S400, the plurality of computing resources 100 may transmit or receive requests, responses, and data based on the optical signals. In step S500, the controller 300 may determine whether to maintain, change, and/or terminate the connection paths between specific computing resources and control the connection paths.

In one embodiment, the controller 300 may control the setting of the connection paths between the plurality of computing resources 100. The controller 300 may control the computing system 10 to operate normally and perform computations.

In one embodiment, the master 110 may include the function of an optical switch controller. The master 110 may be designated as a computing resource such as a host CPU.

In one embodiment, based on not receiving a termination signal for the connection paths between specific computing resources by the controller 300, the master 110 may repeat the generation of new switching time information to maintain and/or change the existing switching time information.

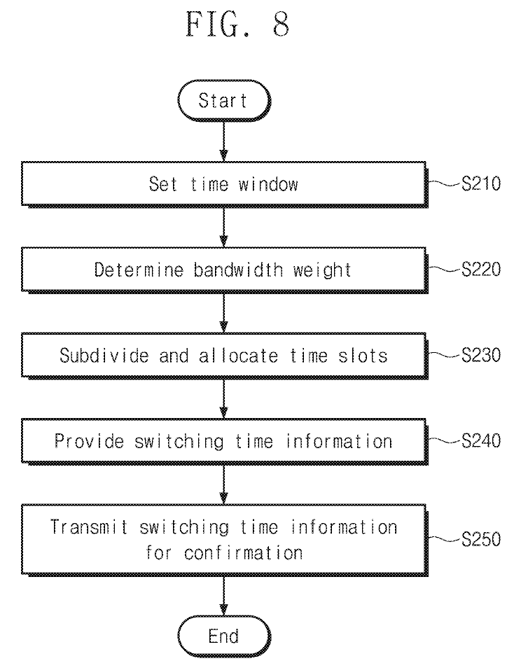

FIG. 8 is a flowchart illustrating an operation method for a master to generate switching time information in step S200. FIG. 8 will be described together with FIGS. 1 and 4.

Referring to FIGS. 1, 4, and 8, in step S210, the master 110 may set a time window 101 for communication with the plurality of computing resources 100. In step S220, the master 110 may determine a bandwidth weight for each of the plurality of computing resources 100. In step S230, the master 110 may subdivide and allocate the time window 101 into a plurality of time slots 102 based on the bandwidth weight. In step S240, the master 110 may provide switching time information to the computing resource(s) connected to the master 110 in each of the plurality of time slots 102. In step S250, the computing resource(s) connected to the master 110 may transmit switching time information for confirmation to the master 110.

In one embodiment, the time window 101 may be a set of a plurality of time slots 102, which are time periods defining the communication channel time of the plurality of computing resources. The entire period of the time window 101 may be a set of a plurality of time slots 102 divided by the destination computing resource. The plurality of time slots 102 may include a first time slot 102a, a second time slot 102b, and an nth time slot 102n.

In one embodiment, the master 110 may determine the allocation capacity of the input/output bandwidth for one computing resource based on the bandwidth weight. For example, a single port included in the master 110 accessing two devices with the same bandwidth, the weights of the two devices may be determined as 50% each.

In one embodiment, the bandwidth weight may be adjusted by the number of flits included in each of the plurality of time slots 102. A flit may be a basic unit of data transmission in the computing system of FIG. 1. In this document, data (or a frame) included in a time window and/or a time slot may be referred to as a flit.

In one embodiment, the first time slot 102a may include a guard time 103, which is a time period for preventing collisions and interference of requests, responses, and data and for switching stabilization, a header 104, and a data transmission period 105, which is a time period for transmitting requests, responses, and data between a plurality of computing resources. The guard time 103 may not be included in the effective bandwidth for communication. The guard time 103 may be dependent on the switching time. For example, by using a switching element with a short switching time, the guard time 103 may be shortened, and the effective bandwidth may be increased.

In one embodiment, the master 110 may provide switching time information for transmitting or receiving requests, responses, and data in the allocated time slot for each device through an OCXL and NVLink interface. For example, the switching time information may include the time window, the number of time slots, the index of the allocated time slot, and the maximum number of flits.

In one embodiment, the switching time information may be used for the computing resource(s) other than the master 110 to synchronize time through a recovered receive clock. Through this, the computing resource(s) other than the master 110 may correct and synchronize the internal clock and the receive clock and use the synchronized internal clock as a transmission clock.

In one embodiment, computing resources other than the master may transmit switching time information for confirmation to the master 110 through the header 104 or an internal message of the OCXL and NVLink interface. For example, the switching time information for confirmation may include the time window 101, the number of time slots, the index of the allocated time slot, and the maximum number of flits.

In one embodiment, the header 104 may include a specific bit string or pattern. The master 110 may identify (or determine) the reference time of the periodic switching time information based on the specific bit string or pattern included in the header 104.

In one embodiment, the master 110 may recognize (or identify) the reference time of computing resources other than the master based on the specific bit string or pattern contained in the field of the header 104 received at the receiver of the OCXL and NVLink interface, switching time information for confirmation, and a fixed loop-back delay, and adjust and/or manage the reference time as needed.

In one embodiment, the OCXL and NVLink interfaces of the computing resources other than the master may be synchronized based on the switching time information from the master 110. The OCXL and NVLink interfaces of the computing resources other than the master may also synchronize the transmission clock based on the clock recovery of the received signal, thereby maintaining the time synchronization of the switching domain.

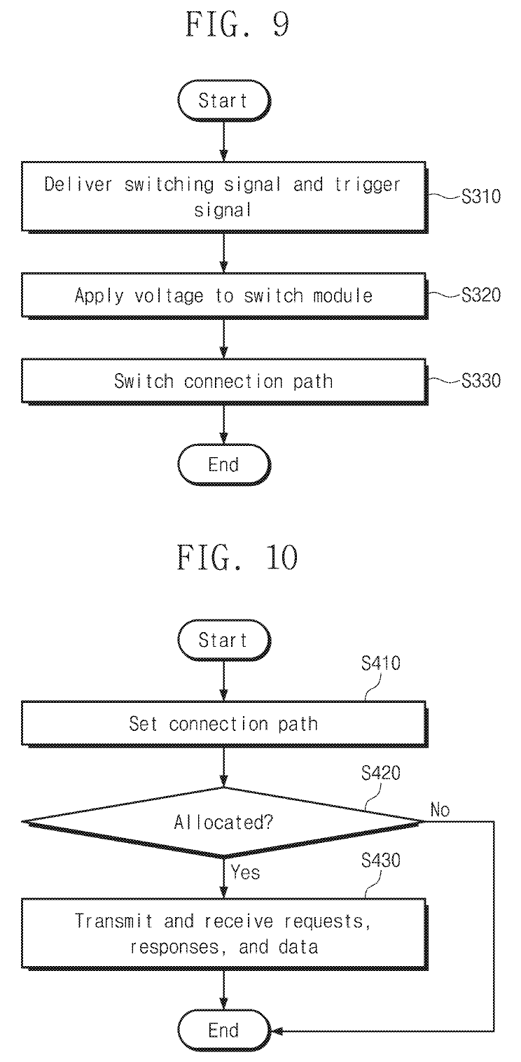

FIG. 9 is a flowchart illustrating an operation method for a master to set connection paths of optical signals in step S300. FIG. 9 will be described together with FIG. 2.

Referring to FIGS. 2 and 9, in step S310, the master 110 may deliver a switching signal and a trigger signal to a switch driver 230a included in the dynamic optical switch 200a. In step S320, the switch driver 230a may apply a voltage to a switch module 210a included in the dynamic optical switch 200a. In step S330, the dynamic optical switch 200a may switch the connection paths between the plurality of computing resources 100.

In one embodiment, the switch driver 230a may apply a voltage to the electrodes of a Mach-Zehnder modulator included in the switch module 210a based on the switching signal and the trigger signal. The switch driver 230a may control the applied voltage according to the voltage magnitude, rise/fall time, and application timing required for the normal operation of the switch module 210a.

In one embodiment, the Mach-Zehnder modulator included in the switch module 210a may change the phase of the optical signals based on the applied voltage. A coupler 220a included in the dynamic optical switch 200a may cause optical interference by recombining the optical signals transmitted along different paths. The coupler 220a may adjust the phase difference between the optical signals at the output port according to the optical interference.

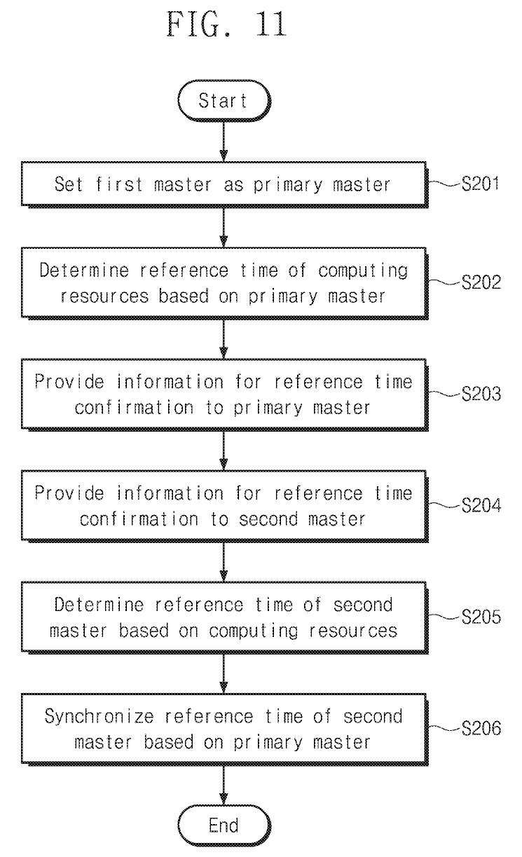

FIG. 10 is a flowchart illustrating an operation method for a master and a plurality of time slots to transmit or receive data in step S400. FIG. 10 will be described together with FIGS. 1 and 4.

Referring to FIGS. 1, 4, and 10, in step S410, the computing resources other than the master may set the connection paths between computing resources for the plurality of time slots 102. In step S420, the plurality of computing resources 100 may determine whether the plurality of time slots 102 are allocated. In step S430, in the case of an allocated time slot 102, the plurality of computing resources 100 may transmit or receive requests, responses, and data in flit units.

In one embodiment, for the plurality of computing resources 100, paths between computing resources may be generated for each of the plurality of time slots 102 by the control of the optical switch controller included in the master 110 and based on the switching time information provided from the master 110.

In one embodiment, the plurality of computing resources 100 may stop the transmission or reception of requests, responses, and data for unallocated time slots 102.

FIG. 11 is a flowchart illustrating an operation method for determining a reference time of switching time information for a plurality of computing resources based on a plurality of masters in step S200.

Referring to FIG. 11, in step S201, when a plurality of masters are designated, a first master included in the plurality of masters may be set as a primary master. In step S202, the reference time of the switching time information of the plurality of computing resources may be determined based on the primary master. In step S203, the plurality of computing resources may provide information for reference time confirmation to the primary master. In step S204, the plurality of computing resources may provide information for reference time confirmation to a second master. In step S205, the reference time of the switching time information of the second master may be determined based on the plurality of computing resources. In step S206, the reference time of the switching time information of the second master may be synchronized based on the primary master.

For example, when a first master and a second master share the transmit or receive port of a third computing resource that is not a master, the reference time of the third computing resource may be determined through the first master, the third computing resource may provide information for reference time confirmation to the first master and the second master. The reference time of the second master, which is not the primary master, may be determined through the third computing resource, and the reference time may be synchronized based on the first master, which is the primary master. The second master may deliver the synchronized switching time information (the switching time information of the computing resources connected to the second master) to the computing resource(s) connected to the second master.

While the embodiments of the present disclosure have been described in detail above, the scope of rights of the present disclosure is not limited thereto, and various modifications and improvements by those skilled in the art using the basic concepts of the present disclosure also fall within the scope of rights of the present disclosure.

A computing system according to the present invention can support connectivity between computing resources even at a distance exceeding a rack-scale through optical expansion, by applying a dynamic optical switch to a computing resource connection interface based on CXL and NVLink switches. Furthermore, the computing system can effectively utilize bandwidth exceeding tens of Tbps, and maximize high-speed communication performance through flexible switching and bandwidth sharing.

What is claimed is:

1. A computing system, comprising:
a plurality of computing resources connected based on a high-speed compute interconnect;
a dynamic optical switch for setting connection paths between the plurality of computing resources; and
a controller for setting a first computing resource among the plurality of computing resources as a master and controlling the setting of the connection paths between the plurality of computing resources by the dynamic optical switch,
wherein the first computing resource set as the master is configured to control the dynamic optical switch.

2. The computing system of claim 1, wherein the plurality of computing resources comprises at least one of a CPU (Central Processing Unit), an accelerator, and a memory, and the high-speed compute interconnect comprises an open interconnect link between the plurality of computing resources.

3. The computing system of claim 1, wherein the first computing resource sets a time window,
wherein the time window is set as a communication channel time of the plurality of computing resources, and
wherein the time window is subdivided into a plurality of Time Slots configured to be allocated to the plurality of computing resources.

4. The computing system of claim 3, wherein each of the plurality of time slots comprises:
a data transmission period, which is a time period for transmitting requests, responses, and data between the plurality of computing resources; and a guard period, which is a time period for preventing collisions and interference of requests, responses, and data, and for switching stabilization.

5. The computing system of claim 4, wherein an input/output bandwidth allocation capacity for each of the plurality of computing resources is determined based on a bandwidth weight, and the bandwidth weight is adjusted based on the number of flits included in each of the plurality of time slots.

6. The computing system of claim 4, wherein the first computing resource provides switching time information for transmitting or receiving the requests, responses, and data to a computing resource connected to the first computing resource in a first time slot among the plurality of time slots, and
wherein the switching time information comprises at least one of the time window, the number of the time slots, an index of an assigned time slot, and a maximum number of flits.

7. The computing system of claim 6, wherein the plurality of computing resources comprise a second computing resource and a third computing resource, and
wherein the second computing resource is configured to:
set connection paths with the third computing resource for each of the plurality of time slots based on the switching time information,
transmit or receive the requests, responses, and data between the second computing resource and the third computing resource in each of the plurality of time slots, and
stop transmitting or receiving the requests, responses, and data in unallocated time slots among the plurality of time slots.

8. The computing system of claim 7, wherein the second computing resource is configured to:
recover a received clock from a received signal,
synchronize a switching time based on the received clock and the switching time information, and
use a synchronized internal clock corrected based on the received clock as a transmission clock.

9. The computing system of claim 1, wherein the dynamic optical switch comprises:
a switch module having a Mach-Zehnder (MZ) interference structure;
a coupler for splitting and combining optical signals of the switch module; and
a switch driver for providing a high-speed voltage optimized for the switch module.

10. The computing system of claim 9, wherein the dynamic optical switch is configured:
bidirectionally; and
to manage and control switching of the connection paths between the plurality of computing resources as a pair of a transmission side and a reception side of the optical signals.

11. The computing system of claim 9, wherein the switch module comprises a Mach-Zehnder modulator, and
wherein the switch module is composed to switch the connection paths based on a phase difference between optical signals at an output port based on a voltage applied to the Mach-Zehnder modulator.

12. The computing system of claim 9, wherein the first computing resource delivers a switching signal and a trigger signal to the dynamic optical switch, and
wherein the switch driver controls the switch module by splitting the high-speed voltage based on the received trigger signal.

13. A computing system, comprising:
a plurality of computing resources connected based on a high-speed compute interconnect;
a dynamic optical switch for setting connection paths between the plurality of computing resources; and
a controller for setting a first computing resource and a second computing resource among the plurality of computing resources as masters and controlling the setting of the connection paths between the plurality of computing resources by the dynamic optical switch,
wherein the first computing resource and the second computing resource generate and deliver switching time information of the plurality of computing resources,
wherein the controller sets the first computing resource as a primary master,
wherein the second computing resource, which is not the primary master, is synchronized based on the first computing resource, and
wherein the first computing resource is configured to control the dynamic optical switch.

14. The computing system of claim 13, wherein the first computing resource sets and controls connection paths of optical signals for communication for each time slot based on the switching time information of the plurality of computing resources.

15. The computing system of claim 13, wherein the dynamic optical switch comprises:
a switch module having a Mach-Zehnder (MZ) interference structure;
a coupler for splitting and combining optical signals of the switch module; and
a switch driver for providing a high-speed voltage optimized for the switch module.

16. An operation method of a computing system for controlling connection paths and a bandwidth between a plurality of computing resources connected based on a high-speed compute interconnect, the method comprising:
setting a first computing resource among the plurality of computing resources as a master by a controller included in the computing system;
setting connection paths of optical signals for communication between the plurality of computing resources by a dynamic optical switch included in the computing system; and
transmitting or receiving requests, responses, and data based on the optical signals by the plurality of computing resources.

17. The operation method of claim 16, further comprising generating switching time information for controlling the plurality of computing resources, and
wherein generating the switching time information for controlling the plurality of computing resources comprises:
setting a time window by the first computing resource;
determining a bandwidth weight based on a transmission demand and a reception demand of the plurality of computing resources by the first computing resource;
subdividing the time window into a plurality of time slots and allocating the plurality of time slots based on the bandwidth weight by the first computing resource; and
providing the switching time information in each of the plurality of time slots by the first computing resource,
wherein the switching time information comprises at least one of the time window, the number of the time slots, an index of an assigned time slot, and a maximum number of flits.

18. The operation method of claim 16, wherein setting the connection paths of the optical signals for communication between the plurality of computing resources comprises:
delivering a switching signal and a trigger signal to a switch driver included in the dynamic optical switch by the first computing resource;
applying a voltage to a switch module included in the dynamic optical switch based on the switching signal and the trigger signal by the switch driver; and
switching the connection path by adjusting a phase difference between optical signals at an output port based on the voltage by the switch module.

19. The operation method of claim 16, wherein transmitting or receiving requests, responses, and data based on the optical signals comprises:
transmitting or receiving the requests, responses, and data in flit units for allocated time slots by the plurality of computing resources; and
stopping the transmission or reception of the requests, responses, and data for unallocated time slots by the plurality of computing resources.

20. The operation method of claim 17, further comprising generating new switching time information by the first computing resource.
